(19) United States
(12) Patent Application Publication
(10) Pub. No.: US 2013/0052363 A1
(43) Pub. Date: Feb. 28, 2013

(54) METHOD FOR MANUFACTURING FILM WITH MULTILAYER

(71) Applicants: Satoshi Kuniyasu, Minami-Ashigara-shi (JP); Tamotsu Saikawa, Minami-Ashigara-shi (JP)

(72) Inventors: Satoshi Kuniyasu, Minami-Ashigara-shi (JP); Tamotsu Saikawa, Minami-Ashigara-shi (JP)

(21) Appl. No.: 13/593,069

(22) Filed: Aug. 23, 2012

(30) Foreign Application Priority Data
Aug. 24, 2011 (JP) 2011-183037
Mar. 22, 2012 (JP) 2012-065737
Aug. 17, 2012 (JP) 2012-180789

(51) Int. Cl. B05D 3/06

(52) U.S. Cl. 427/508

(57) ABSTRACT

A method for manufacturing a film with multilayer, comprising: a preparation process of preparing a plurality of coating liquids including one or more resin containing coating liquids which contain a solvent, a photopolymerization initiator, an actinic ray curable monomer and an actinic ray curable resins having one or more types of molecular weights and the molecular weights of 2500 or more; an application process of applying the plurality of coating liquids to the film in a manner that at least one of a lower layer and an upper layer which contact with each other is formed; a first irradiation process of irradiating the multilayer with actinic ray in a state where the resin containing coating liquid has a solvent concentration of 10% by weight or more; a drying process of drying the multilayer and; the second irradiation process of irradiating the multilayer with actinic ray.

### BACKGROUND OF THE INVENTION

1. Field of the Invention

The present invention relates to a method for manufacturing a film with multilayer and more specifically, a method for manufacturing a film with multilayer, in which multilayer coatings are formed by simultaneously or sequentially applying coating liquids containing solvents on a support by multilayer coating method to form a multilayer.

2. Description of the Related Art

Conventionally, in order to improve visibility of LCD (Liquid Crystal Display) displays, plasma displays, and other display units, it is practiced to mount optical film having antireflection functions, anti-glare functions, and other functions to display units.

Optical films having these functions are manufactured by forming a plurality of functional layers on a surface of a film being a support. As methods for forming a plurality of functional layers, there is a sequential multilayer coating process, but since this process requires coating and drying to be repeated in multiple times, long lead time is needed and consequently, the probability of dust and other foreign substances being mixed between layers increases.

Therefore, attention is attracted to a simultaneous multilayer coating process in place of the sequential multilayer coating process. The simultaneous multilayer coating process enables to form a plurality of layers simultaneously on a film, short lead time is achieved and the probability of dust and other foreign matters entering between layers decreases.

In this regard, however, since the simultaneous multilayer coating process forms a plurality of layers simultaneously, the process has problems that the mixture of interlayer tends to easily occur. In order to solve these problems, an optical film manufacturing method disclosed in Japanese Patent Application Laid-Open No. 2008-250267 simultaneously includes: applying resin compositions containing ionizing radiation curable resins for forming a layer (A) and a layer (B); performing a first ionization radiation irradiation; then, drying the coatings; and performing a second ionization radiation irradiation to cure the coatings. Japanese Patent Application Laid-Open No. 2008-250267 describes that this enables to manufacture an optical film that does not pose a problem for functional separation between layers.

In addition, a clear hard coat film manufacturing method disclosed in Japanese Patent Application Laid-Open No. 2006-10923 as other conventional art that performs simultaneous multilayer coating includes: providing at least two or more clear hard coat layers with a width of 1.2 meters or wider on a transparent plastic substrate, at least one of the layers including active energy radiation curable resin; and simultaneously applying at least a coating liquid for a layer on the substrate side and a coating liquid for the layer on the surface side to form two or more layers; and then drying and curing the coatings. Japanese Patent Application Laid-Open No. 2006-10923 describes that this enables to provide an anti-reflective film with outstanding anti-reflection capability.

### SUMMARY OF THE INVENTION

In this regard, however, only by the contents disclosed in Japanese Patent Application Laid-Open No. 2008-250267 and Japanese Patent Application Laid-Open No. 2006-10923, interlayer mixture was unable to be prevented. The present inventors conducted tests in accordance with examples of Japanese Patent Application Laid-Open No. 2008-250267 and Japanese Patent Application Laid-Open No. 2006-10923; however, although the coating layers were irradiated with UV light at high irradiance right after the application, the coating layers did not cure and interlayer mixture was unable to be prevented.

In view of such circumstances, the present invention aims to provide a method for manufacturing film with multilayer coating that is free from interlayer mixture even when simultaneous multilayer coating or sequential multilayer coating is performed.

Through their extensive research, the inventors have succeeded to invent new arts which are not disclosed in Japanese Patent Application Laid-Open No. 2008-250267 and Japanese Patent Application Laid-Open No. 2006-10923 and to solve the above-mentioned problems.

That is, the above-mentioned problems can be solved by each of the following inventions.

A method for manufacturing a film with multilayer according to the present invention, comprises: a preparation process of preparing a plurality of coating liquids including one or more resin containing coating liquids which contain a solvent, a photopolymerization initiator, an actinic ray curable monomer and an actinic ray curable resins having one or more types of molecular weights and the molecular weights of 2500 or more; an application process of simultaneously or sequentially applying the plurality of coating liquids to the film in a manner that at least one of a lower layer and an upper layer which contact with each other is formed by the resin containing coating liquid when the multilayer is formed by the plurality of coating liquids; a first irradiation process of irradiating the multilayer with actinic ray in a state where the resin containing coating liquid has a solvent concentration of 10% by weight or more, just after the application of the multilayer when simultaneous application has been performed in the application process, or just after the application of the resin containing coating liquid when sequential application has been performed in the application process; a drying process of drying the multilayer which has been simultaneously or sequentially applying the plurality of coating liquids to the film; and the second irradiation process of irradiating the multilayer with actinic ray after the drying process. Here, in the resin containing coating liquid: a total solid content concentration which is obtained by totaling solid contents of the actinic ray curable monomer and solid contents of the actinic ray curable resins, is 30% by weight or more; a solid content concentration of the actinic ray curable resins is 3% by weight or more; and B≧A≧0 (where, A+B=1) is satisfied, wherein A denotes a solid content concentration ratio in the coating liquids of actinic ray curable resins having a molecular weight of 100,000 or more and B denotes a solid content concentration ratio in the coating liquids of actinic ray curable resins having a molecular weight of less than 100,000, among the one or more types of actinic ray curable resins.

Here, in the first irradiation process, when the application process is performed by a simultaneous multilayer coating method, “just after the application of the resin containing coating liquid” means that the coating layer of resin containing coating liquid is irradiated with an actinic ray in a state where the coating has solvent concentration of 10% by weight or more, at the following timings. (A): when a lower layer is formed of a resin containing coating liquid and an upper layer is formed of a coating liquid not being a resin containing coating liquid, after application of the lower layer, the layer is irradiated with an actinic ray and then the upper layer is applied. (B): when a lower layer is formed of a coating liquid not being a resin containing coating liquid and an upper layer is formed of a resin containing coating liquid, after application of the lower layer and application of the upper layer, the layers are irradiated with an actinic ray. (C): when a lower layer is formed of a resin containing coating liquid and an upper layer is also formed of a resin containing coating liquid, it is possible that after application of the lower layer, the layer is irradiated with an actinic ray, and then the upper layer is applied. In addition, it is also possible that after the application of the lower layer and then the upper layer, the layers are irradiated with an actinic ray.

Accordingly, at least either upper or lower layer held in mutual contact is definitely cured and layer mixture can be suppressed.

In addition, in the method for manufacturing a film with multilayer according to the present invention, it is preferable that the applied multilayer is irradiated with actinic ray in the first irradiation process under a condition where a coating layer of the resin containing coating liquid has the solvent of 20% by weight or more.

Accordingly, thin-layer coating at high speed and suppression of interlayer mixture can coexist.

Furthermore, in the method for manufacturing a film with multilayer according to the present invention, it is preferable that the actinic ray is UV light, and an LED-UV light source is used as a UV light source.

Because the LED light source has a narrow wavelength band, the use of an LED light source of a wavelength band that contributes to curing of UV curable monomers and UV curable resins can cure UV curable monomers and UV curable resins remarkably efficiently. In addition, since the LED light source does not generate heat significantly, the LED light source can intrinsically prevent solvents contained in coating liquids from combusting or catching fire by heat.

In addition, in the method for manufacturing a film with multilayer according to the present invention, it is preferable that at least one of the photopolymerization initiators has molar absorption coefficient of 500 L/(mol·cm) or more, with respect to the LED-UV light source wavelength.

Accordingly, polymerization is able to efficiently take place.

The present invention enables to manufacture a film with multilayer by simultaneous multilayer coating method or sequential multilayer coating method while suppressing interlayer mixture.

### BRIEF DESCRIPTION OF THE DRAWINGS

FIG. 1 is a schematic diagram illustrating a cross section of a film with multilayer right after two layers, one of which contains actinic ray curable resin and actinic ray curable monomer, are simultaneously applied by the simultaneous multilayer coating method;

FIG. 2 is a schematic diagram illustrating a cross section of the film with multilayer one of which contains actinic ray curable resin and actinic ray curable monomer, when the multilayer is irradiated with actinic ray;

FIG. 3 is a schematic diagram illustrating a cross section of the film with multilayer one of which contains actinic ray curable resin and actinic ray curable monomer, when the multilayer are not irradiated with actinic ray;

FIG. 4 is an explanation drawing illustrating the condition of actinic ray curable resin and actinic ray curable monomer in a coating layer;

FIG. 5 is a TEM (Transmission Electron Microscope) photo of cross section of Sample A;

FIG. 6 is a TEM photo of cross section of Sample B; and

FIG. 7 is a TEM photo of Sample C.

### DETAILED DESCRIPTION OF THE PREFERRED EMBODIMENTS

Referring now to the drawings, preferred embodiments according to the present invention will be described in detail hereinafter. In the drawings, portions indicated by like reference characters designate like or corresponding elements which have the like and corresponding functions. In addition, when the range of numerical values is indicated by the use of “from . . . to . . . ” in the present specifications, upper limit and lower limit numerical values shown by “from . . . to . . . ” shall be included.

A method for manufacturing a film with multilayer according to the present invention is primarily characterized by forming a film in such a manner that at least either one of upper and lower layers which contact with each other contain actinic ray curable monomer and actinic ray curable resin having a molecular weight of 2500 or more, in a plurality of coatings simultaneously applied on a film (also referred to as a support) to form multilayer, and after the multilayer (coatings) is formed, the coatings are irradiated with actinic ray.

By this, of a plurality of layers formed by a plurality of coatings, at least either one of upper and lower layers which contact with each other contains actinic ray curable monomer and actinic ray curable resin, and therefore, the layer containing them are cured by being irradiated with actinic ray, and as a result, mixture between layers can be prevented. The degree of curing may be such a level or higher that can prevent mixture between layers.

In addition, it is preferable to use ultraviolet curable monomer and ultraviolet curable resin, respectively, as actinic ray curable monomer and actinic ray curable resin, and to irradiate coatings with UV light (ultraviolet rays, also simply called UV) as actinic ray from the LED (Light Emitting Diode) light source.

Of the lights irradiated for curing UV curable monomer and UV curable resin (hereinafter may be collectively referred to as UV resins), the light that contributes to curing of these is a light of a specific wavelength band which the photopolymerization initiator contained in the UV curable monomer and the UV curable resin absorb. And the light irradiated from the LED light source has a comparatively narrow wavelength distribution as compared to the light from mercury lamps, etc.

Consequently, using the LED light source that irradiates the coatings with the UV light of the wavelength band (hereinafter called the effective wavelength band) that activates photopolymerization initiators and hardens UV resins allows almost all energy of irradiation light to be used for curing of UV resins.

On the other hand, mercury lamps used in conventional methods irradiate coatings with a light of a wide wavelength band, and therefore, even if a high-irradiance mercury lamp is used, of the irradiated light, the light having the wavelength band which is absorbed by photopolymerization initiator is slight, and thus, of total energy of irradiation light, only a small amount of energy contributes to curing of coatings by being absorbed by the photopolymerization initiator. Furthermore, energy that does not contribute to curing of coatings becomes heat and may cause organic solvents evaporated from the coatings to ignite. However, the interlayer mixture (mixture between layers) can be prevented even when mercury lamps are used.

It is preferable to use photopolymerization initiators at least one of which have a molar absorption coefficient of 500 L/(mol·cm) or more for LED-UV light source wavelength, as photopolymerization initiators for curing UV monomer and UV resin, and to use an LED light source that emits a light having a wavelength which is the same as or near the absorption peak wavelength of photopolymerization initiators, as a UV light source.

In addition, even in the case of photopolymerization initiators having a light absorption peak in the wavelength of the UV light region, when the absorption peak wavelength is too short, there is a problem of ozone generation. That is, in the event that the wavelength of light that activates the photopolymerization initiator is too short, in particular, when the wavelength is 200 nm or shorter, irradiation with the light of this wavelength ozonizes oxygen in air, resulting in absorption of its irradiation energy, and causing problem of reduction in light energy that reaches photopolymerization initiators. In addition, there is a problem of deterioration of UV curing monomers and UV curable resins by the generated ozone.

Consequently, when photopolymerization initiators having absorption in the wavelength region where ozone is generated are used, it is preferable to initiate photopolymerization by irradiation with light under an inert atmosphere free of oxygen. In this event, “under an inert atmosphere” means “under an atmosphere filled with nitrogen or inactive gas (helium, neon, argon, etc.).”

In this way, the method for manufacturing a film with multilayer can suppress mixture between a plurality of coatings even when the plurality of coatings are fabricated by the simultaneous multilayer coating method. In addition, the use of the LED light source can cure UV resins in coatings safely with reduced energy.

### <Configuration>

The method for manufacturing a film with multilayer according to the present invention is configured mainly by: a preparation process for preparing a plurality of coating liquids including at least one resin containing coating liquid containing actinic ray curable monomer and actinic ray curable resin having a molecular weight of 2500 or more; an application process for applying the plurality of coating liquids on the film to form a multilayer coatings in such a manner that at least one of upper and lower layers contacting with each other is formed by the resin containing coating liquid when the multilayer coatings are formed by the application of the plurality of coating liquids on the film, and a irradiation process for irradiating the multilayer coatings with actinic ray.

The present inventors have found the following by keen researches. That is, the resin containing coating liquid prepared in the preparation process must have solid content concentration of actinic ray curable resins having a molecular weight of 2500 or more to be 3% by weight or more. In addition, the solid content concentration of actinic ray curable monomers must be 1% by weight or more.

In addition, actinic ray curable resins contained in the coating liquids may be one kind or a plurality kinds of actinic ray curable resins having different molecular weights may be contained. In this event, however, if the coating liquids contain actinic ray curable resins having a molecular weight of 100,000 or more, actinic ray curable resins having a molecular weight of less than 100,000 must be contained, and at the same time, it is preferable that actinic ray curable resins having a molecular weight of less than 100,000 are contained more than actinic ray curable resins having a molecular weight of 100,000 or more in weight ratio. This is because in the event that actinic ray curable resins having a molecular weight of 100,000 or more are contained more than actinic ray curable resins having a molecular weight of less than 100,000 in weight ratio, viscosity of the coating liquids increases, which makes difficult to apply the coating liquids. In addition, this causes difficulty in applying the coating liquids to form a thin coating.

In this event, with respect to the amount of actinic ray curable resin having a molecular weight of 100,000 or more and actinic ray curable resin having a molecular weight of less than 100,000 in the coating liquids, the amount of actinic ray curable resin having a molecular weight of 100,000 or more is preferably less than 10% by weight of the amount of actinic ray curable resin having a molecular weight of less than 100,000, and more preferably less than 1% by weight of the amount of actinic ray curable resin having a molecular weight of less than 100,000, and it is most preferable that no actinic ray curable resin having a molecular weight of 100,000 is contained. The lesser the amount of actinic ray curable resin having a molecular weight of 100,000 or more, the less posed are problems of difficulty in application of thin coatings.

In the coating process, gravure coating method, roll coating method, reverse coating method, die-coating method, knife coating method, wire bar coating method, dip coating method, spray coating method, air-knife coating method, curtain coating method, and other various coating methods may be adopted.

In addition, for solvents contained in coating liquids, chloroform, methylene chloride, tetrahydrofuran, ethyl acetate, methyl acetate, methyl ethyl ketone, phenol, nitrobenzene, chlorophenol, chlorobenzene, hexafluoroisopropanol, methylisobutyl ketone, toluene, methanol, and others can be favorably used.

For example, preferably usable actinic ray curable monomers include multifunctional monomers such as (meth)acrylic acid diesters of polyoxyalkylene glycol such as dipentaerythritol hexaacrylate, neopentyl glycol acrylate, 1-6-hexandiol methacrylate, Propylene glycol dimethacrylate and other methacrylic acid diesters of alkylene glycol; triethylene glycol dimethacrylate, dipropylene glycol dimethacrylate, polyethylene glycol dimethacrylate, polypropylene glycol dimethacrylate; methacrylic acid diesters of polyalcohol such as pentaerythritol dimethacrylate; methacrylic acid diesters of ethylene oxide or propylene oxide adducts such as 2,2-bis(4-(acryloxy diethoxy)phenyl)propane, 2,2-bis(4-(acryloxy polypropoxy)phenyl)propane; epoxy methacrylates, urethane methacrylates, polyester methacrylates; and monofunctional monomers; acrylic acid esters such as N-vinylpyrrolidone, ethyl acrylate, propyl acrylate; methacrylic acid esters such as ethyl methacrylate, propyl methacrylate, isopropyl methacrylate, butyl methacrylate, hexyl methacrylate, isooctyl methacrylate, 2-hydroxy ethyl methacrylate, cyclohexyl methacrylate, nonylphenyl methacrylate; tetra furfuryl methacrylate, and its derivatives of modified caprolactone monomers, etc., styrene, alpha-methylstyrene, acrylic acid and their mixtures.

As actinic ray curable monomers, one kind or mixture of a plurality of kinds of multifunctional monomers and monofunctional monomers enumerated above may be used, however, in order to increase coating hardness, multifunctional monomers only may be used or the ratio of multifunctional monomers is preferably set to 80% by weight or more of the overall monomers used.

As actinic ray curable resins, monofunctional or multifunctional acrylates, methacrylates, urethane acrylates, etc. having a molecular weight of 2500 or more may be used. There is no need to specify the upper limit of the molecular weight of the actinic ray curable resins in the inventive concept. However, it is preferable to use actinic ray curable resins having molecular weight of one million or less because these resins can be easily available as general-purpose products.

As polymerization initiators for curing (polymerizing) actinic ray curable resins and actinic ray curable monomers, photopolymerization initiators are preferably used. For example, the photopolymerization initiators include acetophenones, benzoins, benzofenones, phosphine oxides, ketals, anthraquinones, thioxanthones, azo compounds, peroxides (Japanese Patent Application Laid-Open No. 2001-139663, etc.), 2,3-dialkyldion compounds, disulfide compounds, fluoroamine compounds, aromatic sulfoniums, lophine dimers, onium salts, borate salts, active esters, active halogens, inorganic complexes, coumarins, and others.

As supports, TAC (triacetyl cellulose), PET (polyethylene terephthalate), and others can be used.

In the first irradiation process, it is preferable to irradiate the multilayer (coatings) with actinic ray under a wet condition in which coatings contain solvents. This is because in a state where the coatings is dried too much, even if coatings are irradiated with actinic ray after interlayer mixing (interlayer mixture) has advanced, interlayer mixing cannot be prevented anymore.

As the actinic ray, electron beans, ultraviolet ray, electromagnetic wave, particle beams, and others may be used; however, since the equipment is comparatively simple, ultraviolet ray is preferably used. For means for irradiating coatings with UV ray, low-pressure mercury lamps, high-pressure mercury lamps, super-high-pressure mercury lamps, metal halide lamps and other various commercially available UV light sources can be adopted, but an LED light source is preferably used. The reason is that the light emitted from the LED light source has a narrow wavelength band and the ultraviolet light emitted from the LED light source does not include infrared ray. Consequently, the LED light source does not generate heat by infrared light and can prevent solvent gas evaporated from coatings from catching fire or flashing off due to heat.

In addition, the first irradiation process may be performed under an inert gas atmosphere. The reason is that under the atmosphere where no oxygen is present, oxygen does not capture radicals on a surface of the multilayer generated by the photopolymerization initiators to change into ozone. That is, the radicals generated by photopolymerization initiators on the surface side can be efficiently used for UV resin curing.

Furthermore, for a similar reason, it is preferable to remove oxygen from the coating liquids before the application process. By this, oxygen that absorbs the energy of ultraviolet ray is removed and therefore, the energy of ultraviolet ray can be efficiently transmitted to photopolymerization initiators. Here, in order to remove oxygen from the coating liquids, a method for temporarily place the coating liquids under a reduced pressure environment may be adopted.

Furthermore, it is preferable to irradiate coatings with UV light from the coated surface side. The support generally contains a UV absorber in order to prevent deterioration of the support with time. When the coatings are irradiated with UV light from the coated surface side, the UV light does not absorbed by the UV absorber, which enables to prevent loss.

In addition, it is possible to provide a means for reflecting UV light to a side opposite to a side where a UV light source is located, with respect to the support. By this, the reflected UV light passes through inside of the support again and the coating film is irradiated with the UV light, and thus the energy of UV light is effectively used. As means for reflecting UV light, reflector plates such as mirrors, metal sheets, etc. and metal rolls may be used.

Furthermore, an ultraviolet reflective coating may be provided to a support transport means for transporting the support, for example, transport rolls or the rolls may be formed with material that reflects UV light, thereby providing a support transport means itself with a function to reflect UV light. By this, it is no longer necessary to install reflector plates, etc to the film.

After the manufacturing process according to the present invention, processes needed for each product to be fabricated may be performed. For example, when an antireflection film, a hard coat film, etc. are fabricated, after the process according to the present invention, a drying process for evaporate solvents is performed, and further, a UV irradiation process (a second irradiation process) may be performed for curing actinic ray curable monomers and actinic ray curable resins.

### <Operation>

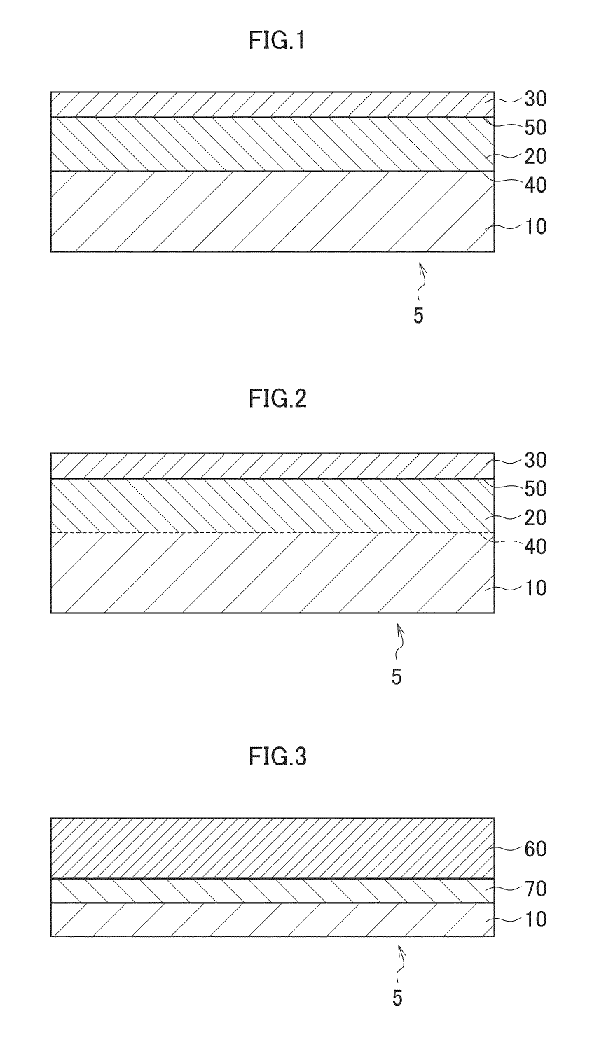

Next, referring to FIG. 1 through FIG. 3, discussion will be made on operation of the present invention. FIG. 1 is a schematic diagram illustrating a cross section of a film with multilayer right after two layers, one of which contains actinic ray curable resins and actinic ray curable monomers, are simultaneously applied by a simultaneous multilayer coating method. FIG. 2 is a schematic diagram illustrating a cross section of a film with multilayer, one of which contains actinic ray curable resins and actinic ray curable monomers, are irradiated with actinic ray. FIG. 3 is a schematic diagram illustrating a cross section of a film with multilayer, one of which contains actinic ray curable resins and actinic ray curable monomers, are not irradiated with actinic ray. Here, actinic ray curable monomers and actinic ray curable resins are contained in a first layer 20. In addition, solvents contained in the first layer 20 are solvents of a type that can penetrate into a support 10.

As shown in FIG. 1, the cross section of a film 5 having multilayer right after the multilayer coating has the first layer 20 located on the support 10, and a second layer 30 located on the first layer 20, and a first interface 40 which is an interface between the support 10 and the first layer 20 and a second interface 50 which is an interface between the first layer 20 and the second layer 30 are clearly identified, respectively.

It is FIG. 2 that shows a cross section of a film with multilayer when the first layer and the second layer are irradiated with actinic ray after the condition shown in FIG. 1. As shown in FIG. 2, a second interface 50 which is an interface between the first layer 20 and the second layer 30 is clearly identified.

This is because the actinic ray curable monomers and actinic ray curable resins contained in the first layer 20 are cured by actinic ray irradiation and therefore mixture occurs between the first layer 20 and the second layer 30 is significantly suppressed. In this way, when a plurality of layers are formed by a simultaneous multilayer coating method, by allowing actinic ray curable monomers and actinic ray curable resins to be contained in at least one of upper and lower layers (coatings) which contact with each other and by irradiating the layers (coatings) with actinic ray after the formation of the layers, mixture between the plurality of layers can be suppressed.

In addition, when the support 10 into which the solvents in the first layer 20 can penetrate is used, the first interface 40 which is the interface between the support 10 and the first layer 20 becomes unclear. This is because the solvents which are contained in the first layer 20 and have properties of penetrating into the support 10, and the actinic ray curable monomers penetrate to the support 10, thus the concentrations of solvents and actinic ray curable monomers are gradually reduced (refractive index gradually varies) from the first layer 20 to the inside of the support 10 in the first interface 40. Therefore, the first interface 40 becomes unclear. However, in this event, the present invention does not limit to use solvents that penetrate to the support.

When the support 10 into which the solvents in the first layer 20 can penetrate is used, if the film with multilayer according to the present invention is used as an optical film, interference of light generated by reflection of light at the first interface 40 can be significantly reduced.

It is FIG. 3 that shows a cross section of a film 5 with multilayer (coatings) when the multilayer is not irradiated with actinic ray after the condition shown in FIG. 1. As shown in FIG. 3, a mixed layer 60 which is a result of the mixing of the first layer 20 and the second layer 30 is formed. This is generated because the multilayer is not irradiated with actinic ray, the first layer 20 is not cured, and therefore the first layer 20 and the second layer 30 are mixed.

In this way, when the UV irradiation is not performed, the first layer and the second layer get mixed, and thus the respective layers cannot serve their functions.

This kind of phenomenon also occurs when actinic ray curable resin having a molecular weight of 2500 or more is not contained in the first layer 20 irrespective of presence or absence of UV irradiation. This is because, when an actinic ray curable resin having a molecular weight of 2500 or more is not contained in the first layer 20, the first layer does not cure irrespective of presence or absence of UV irradiation. When the actinic ray curable resin having a molecular weight of 2500 or more is not contained in the first layer 20, that is, when the actinic ray curable resin to be polymerized does not exist or when the length of molecules of the actinic ray curable resin is too short, molecules of actinic ray curable resin to be polymerized and molecules of actinic ray curable monomers themselves do not come in contact with each other. That is, they are physically separated from polymerization counterparts even if they are activated, and thus they are unable to be polymerized.

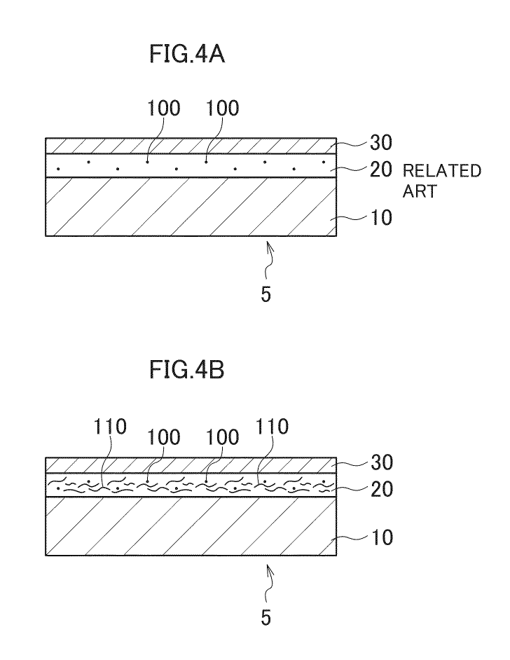

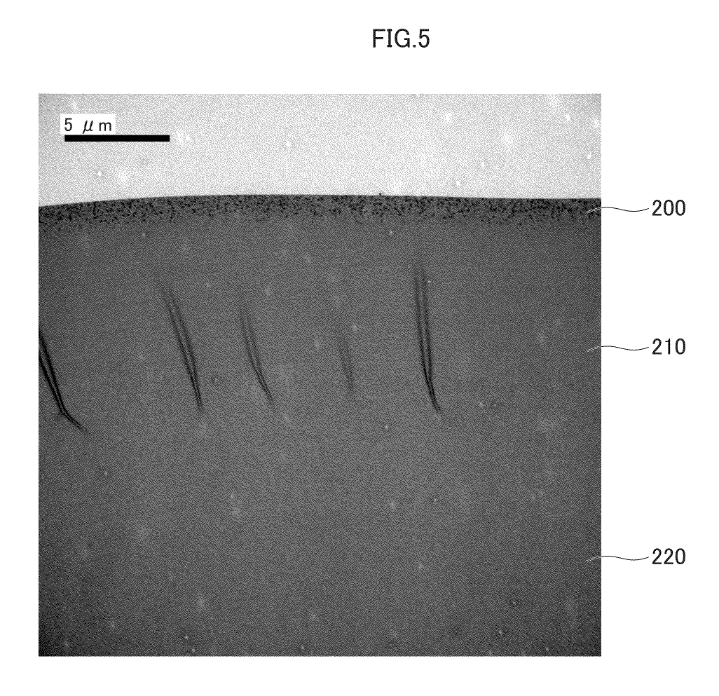

With respect to them, referring to FIG. 4, findings discovered by the present inventors through their keen researches will be further explained. FIG. 4 is an explanation drawing illustrating the condition of actinic ray curable resins and actinic ray curable monomers in coating layer. FIG. 4A is a diagram illustrating the condition in which actinic ray curable monomers 100 only exist in the first layer 20. That is, FIG. 4A illustrates a condition in which coating liquids containing actinic ray curable monomers only are applied to the support, which is one of the conventional arts. In this event, even if actinic ray curable resins are contained in the coating liquids but if the molecular weight of actinic ray curable resins is less than 2500, the length of molecules of actinic ray curable resins is short, and the condition becomes practically the same as that of FIG. 4A.

As shown in FIG. 4A, an actinic ray curable monomer 100 has a short molecular chain because it is a monomer. Consequently, even if actinic ray curable monomers 100 are applied at concentration where a film can be formed, as shown in FIG. 4A, the existence of solvents causes actinic ray curable monomers 100 to exist discretely in solvents and crosslinking points to be physically separated. This makes it difficult to cause polymerization of the monomers, and thus makes it difficult to cause curing of the coatings, even if actinic ray curable monomers are irradiated with actinic ray to activate actinic ray curable monomers 100.

To solve the problem, however, when the concentration of actinic ray curable monomers 100 is increased so as to bring crosslinking points closer to each other, it makes the viscosity of the coating liquids excessively high, and thus makes it difficult to apply the coating liquids to the support.

FIG. 4B illustrates the condition in which the coating liquids containing actinic ray curable resins 110 having a molecular weight of 2500 or more are applied to the support, according to the present invention. As apparent from FIG. 4B, even when the concentration is low, since actinic ray curable resins 110 have long molecules, the crosslinking points of the actinic ray curable resins 110 can contact with each other or contact with crosslinking points of actinic ray curable monomers 100. Consequently, the irradiation with the actinic ray can reliably cause the actinic ray curable resins 110 to polymerize therebetween and between actinic ray curable monomers 100, and to cure the coatings.

In addition, by diligent studies of the present inventors, the present inventors discovered, also, that the solid content concentration of actinic ray curable resins must be 3% by weight or more, and that the solid content concentration totaling the solid content of actinic ray curable resin and the solid content of actinic ray curable monomers must be 30% by weight or more.

In the event that the concentration of actinic ray curable resins is less than 3% by weight, or in the event that the solid content concentration totaling the solid content of actinic ray curable resin and the solid content of actinic ray curable monomers is less than 30% by weight, it is found that the multilayer (coatings) are not sufficiently cured no matter how much the coatings are irradiated with actinic ray and layer mixture results.

With the foregoing description, it is understood that in the present invention, the same mechanism works irrespective of kinds of actinic rays that cure actinic ray curable resins or actinic ray curable monomers, and irrespective of kinds of actinic ray curable resins or actinic ray curable monomers themselves.

In addition, in the above, the case where a plurality of layers are formed by the simultaneous multilayer coating method is explained, however the same explanation may be also applied to the case where a plurality of layers are formed by the sequential multilayer coating method.

In the case of the simultaneous multilayer coating method, the coating of resin containing coating liquid is irradiated with an actinic ray in a state where the coating has solvent concentration of 10% by weight or more, at the following timings. (A): when a lower layer is formed of a resin containing coating liquid and an upper layer is formed of a coating liquid not being a resin containing coating liquid, after application of the lower layer, the layer is irradiated with an actinic ray and then the upper layer is applied. (B): when a lower layer is formed of a coating liquid not being a resin containing coating liquid and an upper layer is formed of a resin containing coating liquid, after application of the lower layer and application of the upper layer, the layers are irradiated with an actinic ray. (C): when a lower layer is formed of a resin containing coating liquid and an upper layer is also formed of a resin containing coating liquid, it is possible that after application of the lower layer, the layer is irradiated with an actinic ray, and then the upper layer is applied. In addition, it is also possible that after the application of the lower layer and then the upper layer, the layers are irradiated with an actinic ray.

### <Evaluation 1>

Next, discussion will be made on evaluation contents and evaluation results on the method for manufacturing a film having multilayer (coatings) according to the present invention. Evaluation samples were prepared by forming coatings by applying coating liquids containing actinic ray curable resins having a molecular weight of 2500 or more to the support under predetermined conditions using an extrusion type coater (coating apparatus), irradiating formed coatings with ultraviolet ray (UV) (hereinafter, only for Sample A), and then via a drying process, irradiating the coatings with UV to cure the layers. In this evaluation, on the supports, two layers of coatings were formed. UV curable resins and UV curable monomers were respectively contained as actinic ray curable resins and actinic ray curable monomers in a lower layer (layer in contact with the supports).

Under the following conditions, Samples A, B, and C were prepared and were evaluated by taking TEM (Transmission Electron Microscope) pictures of cross sections of relevant samples.

Sample A: Two layers were formed by the simultaneous multilayer coating method, and after application of the two layers, the coatings (layers) were irradiated with UV from an LED light source under a condition in which coatings contained solvents of 10% by weight.

Sample B: Two layers were formed by the simultaneous multilayer coating method, and after application of the two layers, the coatings (layers) were not irradiated with UV under a condition in which coatings contained solvents of 10% by weight.

Sample C: Two layers were sequentially formed one by one.

Details of evaluation will be described as follows:

### (1) Preparation of the Support

As supports, triacetyl cellulose film (TAC-TD80U (trademark), commercially available from FUJIFILM Corporation, thickness of 80 μm) was prepared.

### (2) Preparation of Coating Liquids

As coating liquids for a lower layer (layer in contact with the support) and an upper layer (layer formed on the lower layer), coating liquids of the following compositions were prepared, respectively.

Coating Liquid for the Lower Layer

| | |
|---|---|
| Solvent (one-to-one mixture of methyl ethyl ketone | 50% by weight |
| and methyl acetate) | |
| UV curable monomer (KAYARAD (trademark) | 32.0% by weight |
| PET-30 having molecular weight of 298, commercially | |
| available from Nippon Kayaku Co. Ltd.) | |
| UV curable resin (Miramer SC2152 (trademark), | 15% by weight |
| urethane acrylate having molecular weight of 20,787, | |
| commercially available from Toyo Chemicals Co. | |
| Ltd.) | |
| Polymerization initiator (Irgacure 369 (trademark) | 1.5% by weight |
| commercially available from BASF) | |
| Polymerization initiator (Irgacure 127 (trademark) | 1.5% by weight |
| commercially available from BASF) | |

Coating Liquids for the Upper Layer

| | |
|---|---|
| Solvent (one-to-one mixture of methyl ethyl ketone | 70% by weight |
| and methyl acetate) | |
| Colloidal silica | 10% by weight |
| UV curable monomer (KAYARAD (trademark) | 14.4% by weight |
| PET-30 having molecular weight of 298, commercially | |
| available from Nippon Kayaku Co. Ltd.) | |
| UV curable resin (Miramer SC2152 (trademark), | 5% by weight |
| urethane acrylate having molecular weight of 20,787, | |
| commercially available from Toyo Chemicals Co. | |
| Ltd.) | |
| Polymerization initiator (Irgacure 369 commercially | 0.6% by weight |
| available from BASF) | |

### (3) Sample Preparation

Sample A

Using an extrusion type die coater, the prepared coating liquids were applied in such a manner that an upper layer had wet thickness of 3.5 μm and a lower layer had wet thickness of 25 μm. Thereafter, drying and the second UV irradiation were performed. The conveyance speed of the support was 30 m/min.

In the first UV irradiation, the coatings were irradiated with UV under the conditions in which the coatings contain the solvent of 45% by weight (0.3 seconds after the application of coating liquids), at the UV irradiance of 10 mW/cm² and amount of UV irradiation of 10 mJ/cm². For the first UV irradiation, a UV irradiation equipment employing LED (Model OX224 (trademark) available from Sentec Corp. Ltd.) was used.

Sample B

Using an extrusion type die coater, prepared coating liquids were applied on the support so that the upper layer had wet thickness of 3.5 μm and the lower layer had wet thickness of 25 μm. Thereafter, drying and UV irradiation were performed. The support conveyance speed was 30 m/min.

Sample C

Using an extrusion type die coater, the prepared coating liquid for lower layer was applied on the support so that the lower layer had wet thickness of 25 μm. Thereafter, drying and UV irradiation were performed. Furthermore, using an extrusion type die coater, the prepared coating liquid for upper layer was coated over the coating (the lower layer), and thereafter, drying and UV irradiation were performed. The support conveyance speed was 30 m/min.

### (4) Sample Evaluation

For sample evaluation, interface clarity test was conducted on the interface between the support and the lower layer, and the interface between the lower layer and the upper layer.

Clarity Test of the Interface

A cross section vertical to a coating surface of the prepared film having multilayer (coatings) was enlarged at 5000 times magnification and observed using TEM (transmission electron microscope).

### (5) Evaluation Results

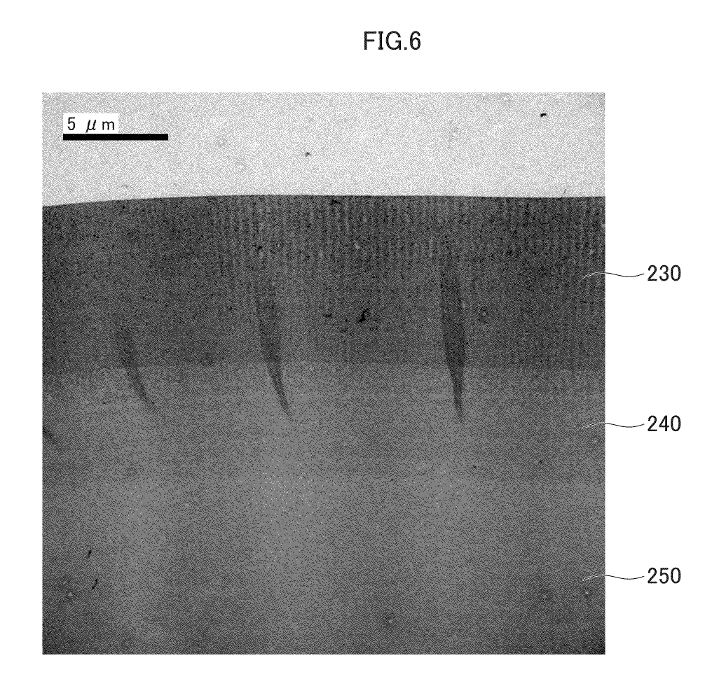

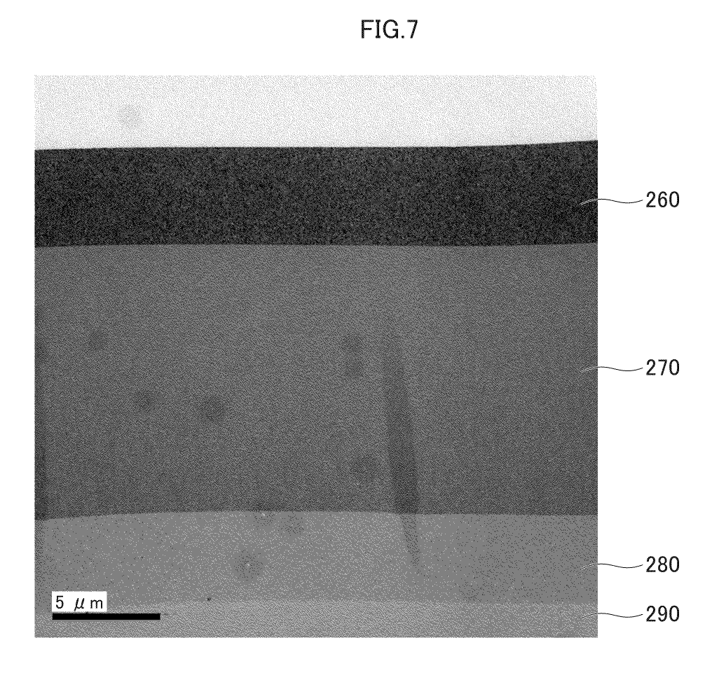

FIG. 5 through FIG. 7 show TEM photographs taken by the evaluation. FIG. 5 is a TEM photograph of a cross section of Sample A. FIG. 6 is a TEM photograph of a cross section of Sample B. FIG. 7 is a TEM photograph of Sample C.

Referring to FIG. 5, which is the TEM photograph of Sample A, the upper layer 200 and the lower layer 210 are clearly separated, which indicates that these two layers are not mixed. In this event, black particulate matters in the upper layer 200 are silica particles contained in the coating liquid used for the upper layer 200.

In this way, by making UV curable resins having the molecular weight of 2500 or more included in at least one of upper and lower layers, and by irradiating the layers (coatings) with UV light after the layers are formed, the layer containing the curable resins is cured, and the mixing (mixture) of the upper layer and the lower layer can be suppressed.

In such event, the present inventors have discovered through their diligent studies that in order to prevent the mixing of the upper layer and the lower layer, it is required that the UV curable resins must have a molecular weight of 2500 or more. By letting UV curable resins having a molecular weight of 2500 or more contained in at least one layer and irradiating the layers with UV light, the layer cures to an extent so as not to mix with other layers. In the when a molecular weight of UV curable resins is less than 2500, the layer does not cure sufficiently no matter how much the layers are irradiated with UV light, and thus interlayer mixture occurs.

In addition, the interface between the lower layer 210 and the support 220 is not clear. In this case, the solvent contained in the lower layer 210 having properties of penetrating into the support penetrate into the support 220 together with UV curable monomers and cure in a state where the concentrations of the solvent and UV curable monomers gradually reduced from the lower layer side to the support side, resulting in the unclear interface.

Because the interface is not clear in this way, distribution of refractive index is also gradually varied from the lower layer side to the support side. Therefore, the light incoming from the outside is not reflected at this interface and interference is difficult to occur. That is, performance as an optical film is improved.

Referring to FIG. 6, which is a TEM photograph of Sample B, a mixture layer 230 which is a mixture of the upper layer and the lower layer is formed. This is because Sample B uses coating liquids having the same composition as that of Sample A but is not irradiated with UV light, the lower layer in which UV curable monomers and UV curable resins are included does not cure, and thus the upper layer and the lower layer get mixed.

In this way, when at least one of the upper layer and lower layer is not cured, it causes the mixture of the upper layer and the lower layer.

In addition, between the mixture layer 230 and the support 250, an intermediate layer 240 is formed, the intermediate layer which is formed by penetration of the solvent in the lower layer and the UV curable monomers into the support 250. This intermediate layer 240 is formed because the layers are not irradiated with UV, the lower layer does not cure, the solvent and UV curable monomers in the lower layer penetrate into the support 250, and concentrations of the solvent of the lower layer, UV curable monomers and support 250 reach a kind of equilibrium state.

Between this mixture layer 230 and the intermediate layer 240, the interface is clear, and distribution of refractive index significantly varies at this interface. The light from the outside is reflected at this interface to cause interference. Consequently, better performance as an optical film is provided by Sample A. Furthermore, because the interface between the intermediate layer 240 and the support 250 is clear, too, in the same manner, distribution of refractive index varies significantly at this interface, and the light from outside is reflected at this interface to cause interference. Consequently, still better performance as an optical film is provided by Sample A.

Referring now to FIG. 7, which is a TEM photograph of Sample C, an upper layer 260 and a lower layer 270 are clearly separated. This is because without simultaneously coating the multilayer, after the lower layer 270 is applied, the lower layer 270 is dried to a certain extent, and then the upper layer 260 is applied. The thickness differs between the upper layer 260 of FIG. 7 and the upper layer 200 of FIG. 5, even though the magnification of TEM photographs of Sample C of FIG. 7 is the same as Sample A of FIG. 5. The reason of the difference in thickness resides is that the upper layer is formed to have 1.5 μm thickness in Sample A of FIG. 5, whereas the upper layer is formed to have 4 μm thickness in Sample C of FIG. 7.

In addition, between a support 290 and the lower layer 270, an intermediate layer 280 is formed. Similar to the case of Sample B of FIG. 6, the intermediate layer 280 is formed, because the layers are not irradiated with UV, the lower layer does not cure, the solvent and UV curable monomers in the lower layer do not penetrate into the support 250, and concentrations of the solvent of the lower layer, UV curable monomer and support 250 reach a kind of equilibrium state. Consequently, like the case of Sample B, interference occurs and therefore, Sample A is preferable.

In this way, in Sample C, coating is performed layer by layer and layer mixture is difficult to occur, but the production lead time increases. In addition, because coating is repeatedly performed many times, possibility of generation of point-like defects increases by entrapping dust and dirt.

In such event, the inventors of the present invention have discovered through their diligent studies that it is preferable to irradiate the multilayer (coatings) with UV light at the irradiance of 10 mW/cm² or more and amount of irradiation of 10 mJ/cm² or more.

Furthermore, the inventors of the present invention have discovered the following findings by further evaluations about the molecular weight of UV curable resins contained in coating liquids. That is, UV curable resins contained in coating liquids may be a UV curable resin having one kind of molecular weight or may be a UV curable resin having a plurality of (various) molecular weights and/or multiple types of UV curable resins.

In addition, when UV curable resins having a molecular weight of 100,000 or more is included in the coating liquid, it is required that UV curable resins having a molecular weight of less than 100,000 is also included, and that B>A≧0 is satisfied wherein A % by weight denotes the solid content concentration of UV curable resins having a molecular weight of 100,000 or more in a coating liquid, and B % by weight denotes the solid content concentration of UV curable resins having a molecular weight of less than 100,000 in the coating liquid. It is more preferable that 0.1 B>A≧0 is satisfied, and the most preferable that 0.01 B>A≧0 is satisfied. By this, the problem that thin-film application becomes difficult is less likely to occur.

Here, in the evaluation above, further evaluation is performed for the sample below.

Sample D

Using an extrusion type die coater, the prepared coating liquid for lower layer was applied to a support in such a manner that the lower layer had wet thickness of 25 μm. Right after that, the first UV irradiation was performed. Furthermore, using an extrusion type die coater, the prepared coating liquid for upper layer was coated over the coating (the lower layer), and thereafter, the drying and the second UV irradiation were performed. The support conveyance speed was 30 m/min.

The lower layer was irradiated with UV under a state where the coating of the coating liquid for lower layer includes solvent of 45% by weight (0.3 seconds after the application of the coating liquids), at the UV irradiance of 10 mW/cm² and amount of UV irradiation of 10 mJ/cm². For UV irradiation, a UV irradiation equipment employing LED (Model OX224 (trademark) available from Sentec Corp. Ltd.) was used.

Sample E

Using an extrusion type die coater, the prepared coating liquid for upper layer was applied to a support in such a manner that the upper layer had wet thickness of 25 μm. Furthermore, using an extrusion type die coater, the prepared coating liquid for lower layer was coated over the coating (In Sample E, the lower layer and upper layer were reversed compared to Sample D). Right after that, the first UV irradiation was performed. Thereafter, the drying and the second UV irradiation were performed. The support conveyance speed was 30 m/min.

The layers were irradiated with UV under a state where the coating of the coating liquid for lower layer includes solvent of 45% by weight (0.3 seconds after the application of the coating liquids), at the UV irradiance of 10 mW/cm² and amount of UV irradiation of 10 mJ/cm². For UV irradiation, a UV irradiation equipment employing LED (Model OX224 (trademark) available from Sentec Corp. Ltd.) was used.

Then, a cross section vertical to a coating surface of the prepared film having multilayer (coatings) was enlarged at 5000 times magnification and observed using TEM (transmission electron microscope).

Regarding Sample D and E, TEM photographs taken in the evaluation are omitted; however, the same advantageous effects as those of Sample A could be achieved. That is, the interlayer mixture could be suppressed.

### <Evaluation 2>

Next, discussion will be made on the evaluation on the solvent concentration and coating properties in the first actinic ray irradiation process. In the actinic ray irradiation process, the initial solvent concentration (% by weight) in coatings was varied in the range from 5% to 30% and coating properties were evaluated. The evaluation was performed under the same conditions as Evaluation 1, with the actinic ray irradiation position and conveyance speed unchanged except for the coating solvent concentrations. Coating properties were visually evaluated. The case where coatings was performed without no problem and free of any nonconformity was judged Excellent, the case where coatings containing defects but being of a level of no problem as product were judged Fair, and coatings containing defects and nonconformity which could not be allowed as product were judged Poor. The evaluation results are shown as follows:

TABLE 1

| | Solvent concentration in | Evaluation |
|---|---|---|
| | first actinic ray irradiation | results of |
| | process (% by weight) | coating properties |
| Example 1 | 30 | Excellent |
| Example 2 | 20 | Excellent |
| Example 3 | 15 | Fair |
| Example 4 | 10 | Fair |
| Comparative Example 1 | 8 | Poor |
| Comparative Example 2 | 5 | Poor |

According to the evaluation results, the coating properties when the solvent concentration is 20% by weight or more in the first actinic ray irradiation process was satisfactory. Based on this, the higher the solvent concentration at the time of coating application, the lower was the liquid viscosity, suggesting that such coating liquid can be applied for thin layer coating or at high speed coating, or both of them, even at the same coating gap value.

### <Evaluation 3>

Next, discussion will be made on the evaluation on changes of curing efficiency caused by difference in molar absorbance coefficient of polymerization initiators. This evaluation was performed under the same conditions as Evaluation 1, with the kind of polymerization initiators only changed.

For the curing efficiency, the case in which coatings could be cured at the amount of irradiation of 10 to 20 mJ/cm² or less was judged Excellent, the case in which coatings could be cured at the amount of irradiation of 20 to 30 mJ/cm² or less was judged Good, and the case in which coatings could be cured at the amount of irradiation larger than 30 mJ/cm² was judged Fair.

The light absorbance coefficient [L/(mol·cm)] of each polymerization initiator with respect to 365 nm light is shown as follows:

Irgacure 184: 50

Irgacure 819: 1200

Irgacure 2959: 0

Irgacure 369: 3400

The evaluation results are shown as follows:

TABLE 2

| | Addition of initiator having the light absorbance | |
|---|---|---|
| | coefficient of 500 or more in the LED-UV light | Curing |
| | source wavelength | efficiency |
| Sample 1 | Added | Excellent |
| | (Irgacure 184 and 369) | |
| Sample 2 | Added | Good |
| | (Irgacure 184 and 819) | |
| Sample 3 | Added | Fair |
| | (Irgacure 184) | |

As shown by the results above, when at least one of photopolymerization initiators has the molar absorbance coefficient in LED-UV light source wavelength of 500 (L/(mol·cm)) or more, the curing efficiency can be improved.

The method for manufacturing a film with multilayer according to the present invention can be applied in various fields. For example, application of the method to products necessary to form multiple layers of coatings which provide various functions can manufacture a film with multilayer with outstanding performance and quality with a short lead time, because layer mixture is suppressed even when multilayer coating is performed.

What is claimed is:

1. A method for manufacturing a film with multilayer, comprising:
a preparation process of preparing a plurality of coating liquids including one or more resin containing coating liquids which contain a solvent, a photopolymerization initiator, an actinic ray curable monomer and an actinic ray curable resins having one or more types of molecular weights and the molecular weights of 2500 or more;
an application process of simultaneously or sequentially applying the plurality of coating liquids to the film in a manner that at least one of a lower layer and an upper layer which contact with each other is formed by the resin containing coating liquid when the multilayer is formed by the plurality of coating liquids;
a first irradiation process of irradiating the multilayer with actinic ray in a state where the resin containing coating liquid has a solvent concentration of 10% by weight or more, just after the application of the multilayer when simultaneous application has been performed in the application process, or just after the application of the resin containing coating liquid when sequential application has been performed in the application process;
a drying process of drying the multilayer which has been simultaneously or sequentially applying the plurality of coating liquids to the film; and
the second irradiation process of irradiating the multilayer with actinic ray after the drying process, wherein
in the resin containing coating liquid,
a total solid content concentration which is obtained by totaling solid contents of the actinic ray curable monomer and solid contents of the actinic ray curable resins, is 30% by weight or more,
a solid content concentration of the actinic ray curable resins is 3% by weight or more, and
B≧A≧0 (where, A+B=1) is satisfied, wherein A denotes a solid content concentration ratio in the coating liquids of actinic ray curable resins having a molecular weight of 100,000 or more and B denotes a solid content concentration ratio in the coating liquids of actinic ray curable resins having a molecular weight of less than 100,000, among the one or more types of actinic ray curable resins.

2. The method for manufacturing a film with multilayer according to claim 1, wherein the applied multilayer is irradiated with actinic ray in the first irradiation process under a condition where a coating layer of the resin containing coating liquid has the solvent of 20% by weight or more.

3. The method for manufacturing a film with multilayer according to claim 1, wherein
the actinic ray is UV light, and
an LED-UV light source is used as a UV light source.

4. The method for manufacturing a film with multilayer according to claim 3, wherein at least one of the photopolymerization initiators has molar absorption coefficient of 500 L/(mol·cm) or more, with respect to the LED-UV light source wavelength.
